(19) United States
(12) Patent Application Publication
(10) Pub. No.: US 2014/0191913 A1
(43) Pub. Date: Jul. 10, 2014

(54) TECHNIQUES FOR STANDARDIZING ANTENNA ARCHITECTURE

(71) Applicant: INTERMEC IP CORP., Everett, WA (US)

(72) Inventors: Oliver Ge, Cedar Rapids, IA (US); Paul Hulett, Cedar Rapids, IA (US); Dana Utt, Cedar Rapids, IA (US)

(73) Assignee: INTERMEC IP CORP., Everett, WA (US)

(21) Appl. No.: 13/737,892

(22) Filed: Jan. 9, 2013

(51) Int. Cl. H01Q 1/22

(52) U.S. Cl. CPC H01Q 1/2258
USPC 343/720

(57) ABSTRACT

Technology for standardizing an antenna design for a computing device includes an antenna element in the shape of an object that is commonly useful with multiple, different computing products. For example, in one embodiment the antenna element is a bracket for holding a stylus or other object within a stylus chamber that is associated with the computing device. The dimension and composition of the antenna remain relatively constant to provide a consistent radiation pattern requiring little or no redesign when implemented across the different products, since it may be placed at an edge of a device, by a stylus holder, or similar, common location that is a distance from a ground plane and device circuitry.

### BACKGROUND

Computing device's (e.g., mobile phones, tablets, GPS devices, PDAs, notebooks, laptops, etc.) are currently relied upon to perform increasingly more tasks. For instance, a modern mobile phone often contains several components, such as one or more cameras, scanners, graphical processors, and wireless communications (e.g., WiFi, Bluetooth, FM/AM radio, CDMA/3G/LTE components). At the same time, public demand, followed by advances in technology, have miniaturized mobile device components in addition to the constituent fixtures (e.g., boards, screws, etc.) that are used to fasten together the mobile device. The concomitant expansion of functionally into an ever miniaturizing mobile device has created a variety of problems.

One problem is how to efficiently design a mobile device such that each component and fixture is positioned to fit into the mobile device's available physical space (i.e., the device's “housing”). Similarly, another problem is an inability to reuse a particular component layout architecture of one computing device manufacture (e.g., Apple, Samsung, etc.) in a variety of other, different computing device manufactures. This lack of reuse can result in increased costs to design and manufacture, each new iteration of a computing device, or a new (or variation of an existing) component layout architecture.

Another problem caused by the expansion of mobile device functionally into an increasingly smaller format is that an antenna element (e.g., a microstrip antenna, printed antenna, a patch antenna, Planar Inverted F Antenna (PIFA), Folded Inverted Conformal Antenna (FICA)), among other various antenna types and configurations), often requires “retuning” to operate efficiently (e.g., adjusting the antenna's impedance to receive a quality signal-to-noise ratio (SNR)) in different mobile device's component layout architectures. For example, wireless device antennas are custom designed to operate with their specific component layout architecture (e.g., PC board, screws, scanners, other wireless components, etc.); however, the different mobile devices, each having different component layout architecture, often require tuning its antennas to meet a desired signal to noise ratio. Furthermore, even if a particular component layout architecture remains relatively the same (e.g., a new generation of last year's mobile device from the same manufacture), an addition of an external component (e.g., a case, bar code reading, credit card reader, strap holder, etc.) can affect the quality of communication transmitted via the antenna and, therefore, require retuning to operate efficiently.

The need exists for a system that overcomes the above problems, as well as one that can provide additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a block diagram of a basic and suitable computing device that may employ aspects of the described technology.

FIG. 2 is an antenna element positioned relative to a chamber internal to a computing device.

FIG. 3 is an antenna element positioned relative to a chamber external to a computing device.

FIG. 4a is an antenna element in the shape of a holding device.

FIG. 4b is an antenna element in the shape of a holding device, positioned relative to a chamber and a stylus.

FIG. 5 are exemplary embodiments that may employ aspects of the described technology.

### DETAILED DESCRIPTION

The inventors have recognized that current technology has failed to efficiently design a ubiquitous antenna architecture that requires little or no antenna tuning or redesign to maintain optimal antenna response (e.g., quality, frequency power, and desired signal-to-noise ratios when implemented in each of different and various types, makes, and models of computer devices, such as smart phones, tablets and other computing devices.

Optimum antenna performance is based at least on the antenna element's shape and material, the free space surrounding the antenna element and the antenna element's position relative to its grounding plane. The described technology implements a ubiquitous antenna architecture based on one or more of the features mentioned above.

In some embodiments, the technology describes an antenna element in the shape of an object that is commonly associated with multiple, different computing devices. For example, in one embodiment the antenna element is or forms a part of a non-conductive bracket for holding a stylus (i.e., a stylus bracket) or other writing element within a stylus chamber (e.g., an enclosure) that is associated with a computing device. The dimension and composition of the bracket remain relatively constant to provide a consistent radiation pattern requiring little or no redesign when implemented across the different products.

The stylus chamber, in some embodiments, is of relatively constant dimension because a stylus is designed to fit in a human hand and, therefore, varies little when implemented across different products. In the practice of antenna design, it is known that, generally, the more free space surrounding an antenna element the better the signal quality. The described technology takes advantage of the free space within the volume of the chamber to maintain optimal antenna response.

An advantage of a stylus-based antenna design, for example, is that a stylus and its chamber/enclosure are commonly implemented on a far end of a computing device (e.g., the top, bottom, left or right of a device's screen). In antenna design, one objective for obtaining an optimum signal quality is to move the antenna element away from a grounding plane (e.g., of the motherboard) to limit the antenna's exposure to noise from electrical components (e.g., a CPU, other antennas, etc.). The position of the stylus-based antenna at the far end or edge of the computing device naturally limits the antenna's exposure to this noise.

Various embodiments of the technology will now be described. The following description provides specific details for a thorough understanding and enabling description of these embodiments. One skilled in the art will understand, however, that the described technology may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this Detailed Description section.

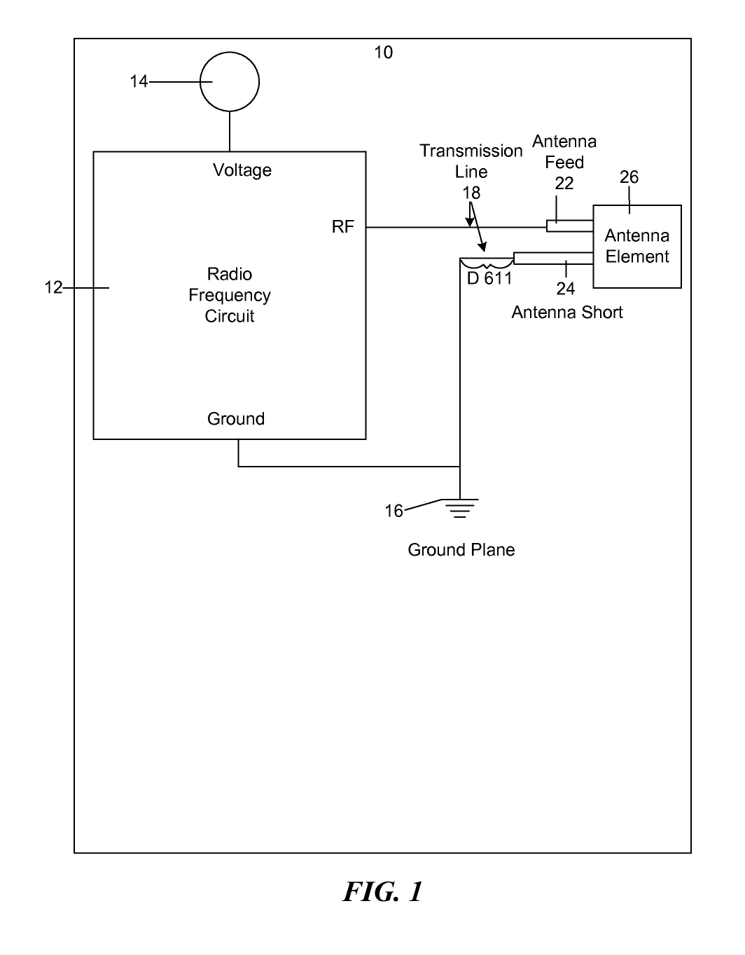

Referring to FIG. 1, the described technology employs a portable computing device 10 having a power source 14 for supplying power to one or more radio frequency circuits 12 (radio frequency circuitry) that is coupled, via transmission lines 18 (e.g., a microstrip, planar waveguide, or strip lines), to an antenna feed 22 and antenna short 24 of an antenna element 26. For example, the antenna element can be configured as a microstrip antenna (e.g., a printed antenna), such as a patch antenna, Planar Inverted F Antenna (PIFA), Folded Inverted Conformal Antenna (FICA), among other various antenna types and configurations. The antenna element 26 and the radio frequency circuitry 12 are each connected to a ground plane 16 that electrically grounds the antenna element 26 and the radio frequency circuitry 12. The ground plane may be formed from a motherboard, a metal frame, or both. The radio frequency circuitry 12 is one or more electronic circuits configured to send and or receive radio signals, via the antenna feed 22, to and or from the antenna element 26. The antenna element 26 can be tuned to a desirable frequency by, e.g., adjusting the position or geometry of the antenna feed 22, the antenna short 22, or both (including the relation to the ground) to affect a change in impedance. The inventors have identified that an impedance of approximately 50 ohms can provide an optimum signal response in some embodiments.

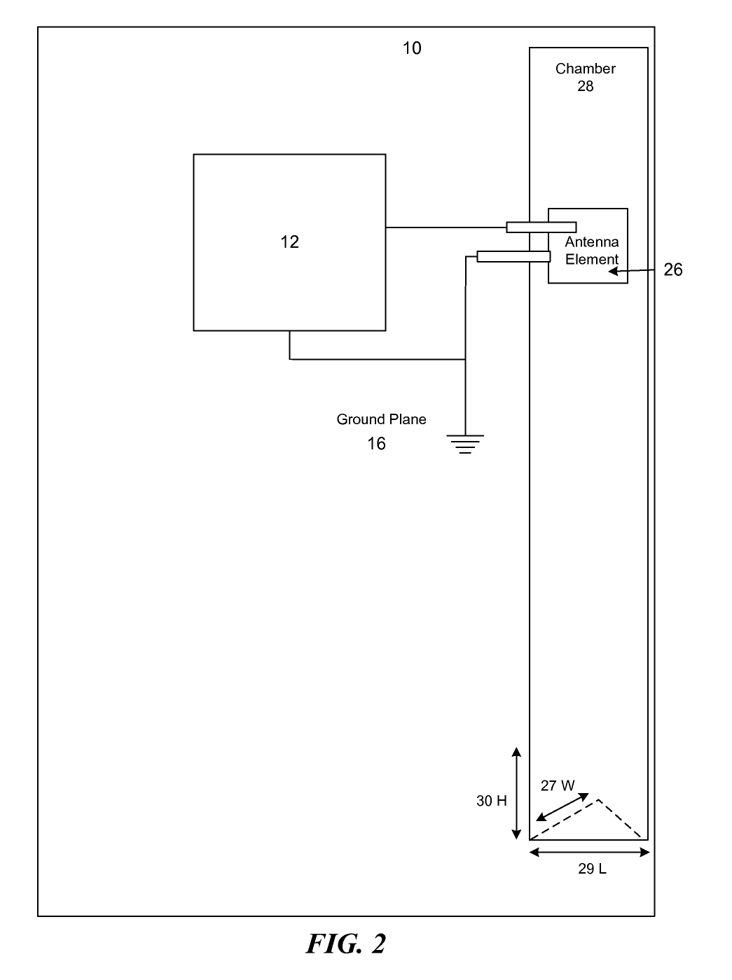

FIG. 2 depicts an antenna element 26 associated with and positioned relative to a chamber 28 such as a chamber for a stylus. The described technology, in some embodiments, positions the antenna element 26 to optimize its signal quality by using free space within the chamber 28. As described below, free space (e.g., air) provides an ideal environment to propagate a radio signal without losing much signal quality relative to electronics of the device, including the ground plane 16. While FIG. 2 depicts antenna element 26 completely within the chamber 28, the antenna element 26 can be positioned partially or completely on top of, underneath, on the side of or at the bottom of chamber 28. A preferred position of the antenna element 26 is on an inside wall of the chamber 28, yet at an outer edge of the device 10, or in another position to maximize on the available free space within chamber 28.

In telecommunication, free-space path loss (FSPL) is the loss in signal strength of a signal that would result from a line-of-sight path through free space (usually air), with no obstacles nearby to cause reflection or diffraction. Free space provides a relatively unobstructed area that reduces the probability of degradation of the antenna element's 26 radiation pattern. Generally, the greater the free space the better the radiation pattern. The chamber 28 has a volume of free space defined by a height 30, width 27 and length 29. The chamber 28 can be of various three-dimensional shapes and sizes. For example, in some embodiments the chamber 28 is a rectangular-based object having a volume equal to a relation of its dimensions (i.e., length (29)×width (27)×height (30)). In another embodiment, the object is cylindrical (e.g., a cylinder) having a volume equal to its dimensions (i.e., πr²h). The inventors have contemplated other objects having a volume of free space suitable for carrying radio signals, such as a prism, cube, tetrahedron, pyramid, cone, trapezoid and or square, for example.

Another criteria to improve antenna efficiency is to distance the antenna element 26 far from electronics of the device 10 and the ground plane 16. This distance between the antenna element 26 and the ground plane 16 is represented as distance 11 in FIG. 2. The inventors have noticed that portable devices employing styluses place stylus chambers at a far edge of the device, thus at a substantial distance, relative to a size of the device, from electronics and ground plane of the device. Thus, a standard optimized antenna may be designed for such stylus-equipped devices, with the knowledge that the same antenna may be used with other current and future device models, since all will most likely have a stylus chamber at a far edge of the device. As shown in FIG. 2, the chamber 28 is shown integrated with, but internal to, the device 10.

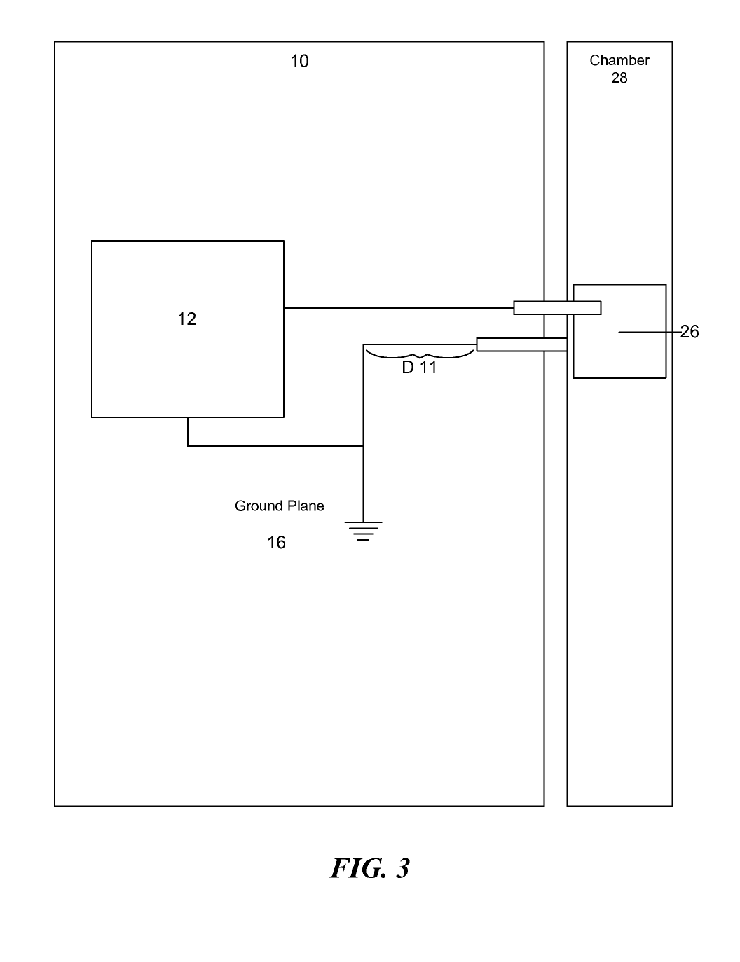

FIG. 3 depicts the antenna element 26 that is associated with an external chamber 28. As previously mentioned, the described technology can utilize the volume of free space within a chamber 28 to optimize the antenna element's 26 signal quality. Additionally or alternatively, the described technology has, in some embodiments, an external chamber 28 to extend the distance 11 between the antenna element 26 and the ground plane 16 by physically partially or completely separating (e.g., isolating) the chamber 28 from the majority of computing device's 10 radio frequency circuit, for example. This increased distance 11 provides for an improvement in the efficiency and signal quality of antenna element 26 because the antenna element 26 will receive less noise from the computing device's 10 components, such as radio frequency circuit 12, for example.

In some embodiments, the chamber 28 is coupled to computing device 10 via the antenna element 26 (i.e., a physical coupling) as shown in FIG. 3. This can provide an advantage of decreasing the amount of additional fastening components that may interfere with signal quality. However, in other embodiments a coupler (e.g., a fastener) (not shown) can attach together the chamber 28 and the computing device 10.

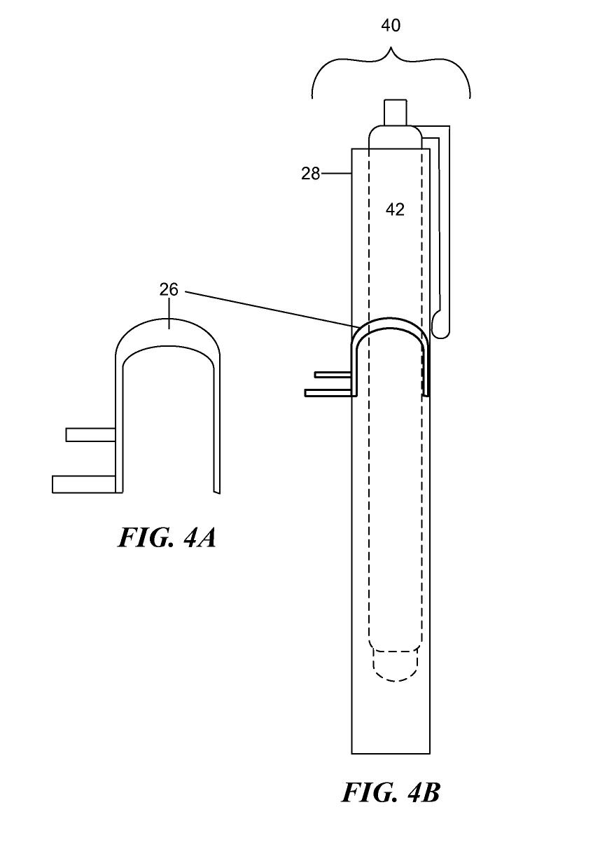

FIGS. 4a-4b exemplify particular embodiments of the described technology that are designed to function with a variety of different types/models of computer devices 10. To provide a unified antenna architecture of ubiquitous design and wide commercial applicability, the size and shape of the antenna element 26 and chamber 28 are selected such that the antenna element 26 requires little to no redesign or tuning, without regard to its implementation, with the knowledge that a stylus chamber will provide sufficient free space and distance from the ground plane. For example, FIG. 4a depicts the antenna element 26 in the shape of a bracket that is capable of holding an object, such as the stylus 42 (or other marking device (not shown)) as shown in FIG. 4b. FIG. 4b depicts a stylus apparatus 40 having the antenna element 26 and chamber 28 (e.g., a stylus holder).

Stylus apparatus 40 has wide market appeal at least because of its common association and use in various computing devices 10. For example, some modern displays are based on “touch” technology (e.g., capacitive, inductive, light based user feedback, etc.) for navigating a graphical user interface (GUI). A stylus apparatus 40 is one preferred embodiment of the described technology because it integrates with modern and future technology by providing an extension to the existing and emerging generation of personal computing devices by providing a non-finger-based tool to navigate a graphical-user-interface, for example. The inventors have contemplated other shapes, types, and sizes of the antenna element 26, the chamber 42 and their combination, such as a pen/pencil holder, magnetic/optical scanning device, credit card reader, camera, strapholder and a handgrip.

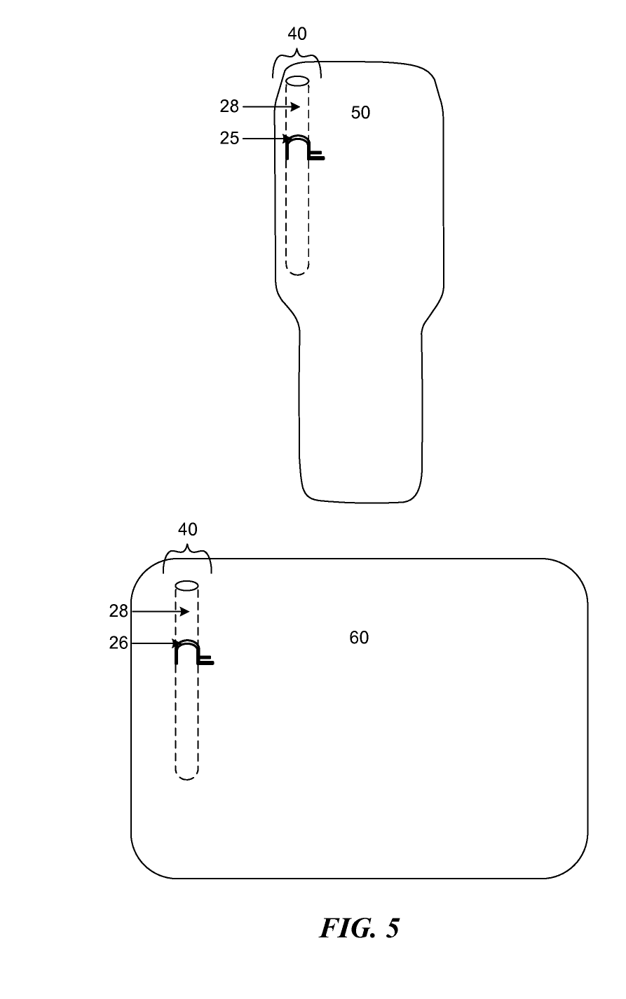

FIG. 5 depicts examples of the stylus apparatus 40 integrated in or associated with different computing devices 10, as shown in FIG. 1. The stylus 42 is removed from the stylus apparatus 40 of FIG. 4b to simplify the display of the chamber 28 and the antenna element 26 and is not a limitation of the described technology. In one embodiment, the stylus apparatus 40 is coupled to a first computing device 50, such as a cell/smart phone, or a handheld computer, such as a bar code scanner/RFID reader. In another embodiment, the stylus apparatus 40 is coupled to a second computing device, such as a laptop or tablet computing device 60. In some embodiments the stylus apparatus 40 is positioned within the body of the mobile device 50, as shown by the chamber's 28 dashed lines; however, the stylus apparatus can be positioned such that it is partially or completely outside the body of the mobile device 50. See FIG. 3, for example.

The described technology can use one or more of the above-mentioned embodiments to provide a simple, reusable antenna design having wide commercial applicability. With the above configuration, low cost, yet efficient, antenna design may be realized across many types of portable/wireless devices and different device models. Features of the described technology optimize the generation and/or receipt of radio frequency signals from or to antenna element 26 across devices having known chambers like the stylus chamber. For example, by increasing the distance 11 of the antenna element 26 from its grounding plane 16 the antenna element's 26 radio signal receives less interference from other devices (e.g., other active devices on the motherboard). Additionally or alternatively, by using an antenna element 26 that has a shape having market appeal, the same antenna element 26 is more likely to be used across multiple different technologies, for example, based at 28 on market demand. Furthermore, by positioning the antenna element 26 in a chamber having free space the antenna element's 26 efficiency provides greater signal quality. These features, alone or in combination, increase signal quality while potentially decreasing manufacturing costs that can be passed on to consumers.

### CONCLUSION

In general, the detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the described technology provided herein can be applied to other systems, not necessarily the system described herein. The elements and acts of the various embodiments described herein can be combined to provide further embodiments.

These and other changes can be made to the described technology in light of the above Detailed Description. While the above description details certain embodiments of the technology and describes the best mode contemplated, no matter how detailed the above appears in text, the described technology can be practiced in many ways. The described technology may vary considerably in its implementation details, while still being encompassed by the technology disclosed herein. As noted above, particular terminology used when describing certain features or aspects of the described technology should not be taken to imply that the terminology is being redefined herein to be restricted to any specific characteristics, features, or aspects of the technology with which that terminology is associated. In general, the terms used in the following claims should not be construed to limit the described technology to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

I/we claim:

1. A computing device for communicating data, via a radio signal, the computing device comprising:
a radio frequency circuit;
an antenna element coupled to the radio frequency circuit; and
an enclosure having a volume of free space,
wherein the antenna element is configured to releasably hold an object within the free space of the enclosure.

2. The computing device of claim 1 wherein the antenna element is:
a planar inverted-F antenna (PIFA), and
a bracket, and
wherein the enclosure has an opening configured to receive the object, wherein the object is a stylus or a marking device.

3. The computing device of claim 1 wherein the enclosure is a scanning device, RFID reader, credit card reader, camera or a strap holder and
wherein the antenna element is configured to couple to the enclosure.

4. An antenna architecture for use with a portable computing device, comprising:
a grounding plane;
a chamber having free space formed within a housing of the portable computing device; and
an antenna element, wherein the antenna element has an antenna ground configured to couple to the grounding plane,
wherein the antenna element is coupled to the chamber,
wherein a signal quality of the antenna element is based at least on an amount of free space within the chamber and a distance between the grounding plane and the antenna ground, and
wherein the chamber is configured to receive an object external to the chamber, and
wherein the chamber is positioned at a distance away from the grounding plane to optimize the signal quality of the antenna element.

5. The antenna architecture of claim 4 wherein the antenna element is configured to be carried by or integrated with many different wireless computing devices that are all configured to carry styluses, and wherein the computing devices differ in functionality and geometry.

6. The antenna architecture of claim 4 wherein the chamber is internal to a body of a computing device,
wherein the chamber is a stylus holder,
wherein the antenna element is a stylus bracket, and
wherein the object is a stylus.

7. The antenna architecture of claim 4 wherein the chamber is external to a body of a computing device, wherein the chamber is a stylus holder, wherein the antenna element is a stylus bracket, and wherein the object is a stylus.

8. The antenna architecture of claim 4 wherein antenna element is a PIFA micro strip, planar waveguide, or strip line antenna in a shape of a holding apparatus.

9. A stylus apparatus comprising:
an antenna element; and
a chamber having a volume of free space,
wherein the antenna element is coupled to the chamber,
wherein the chamber is configured to receive a stylus,
wherein the chamber is configured to couple to any computer device configured to carry a stylus-receiving chamber, and
wherein the antenna element is positioned about the chamber to send a radio signal through a portion of the free space of the chamber.

10. The stylus apparatus of claim 9 wherein the chamber has a cylinder or trapezoidal configuration, wherein the chamber is positionable at an edge of the computing device, and wherein the antenna element is a microstrip antenna in a shape of a stylus bracket.

11. The stylus apparatus of claim 9 wherein the antenna element is a PIFA, and wherein the antenna element is positioned about the chamber to send a radio signal through a majority of the free space of the chamber.

12. A computing device comprising:
a microstrip antenna;
a means for holding the microstrip antenna;
a radio frequency circuit; and
a means for holding the radio frequency circuit, wherein the microstrip antenna is configured to couple together the means for holding the microstrip antenna and the means for holding the radio circuit.

13. The computing device of claim 12 wherein the holding means for the microstrip antenna is a chamber for holding a stylus, the means for holding the radio frequency circuit is a housing for the radio frequency circuit and wherein the housing includes the chamber.

14. The computing device of claim 12 further comprising a means for displaying a graphical user interface (GUI), wherein the means for holding the microstrip antenna is a chamber configured to receive a stylus, wherein the microstrip antenna is a bracket to hold the stylus, the means for holding the radio frequency circuit is a housing for holding the radio circuit, and wherein the housing is isolated from the chamber.

15. The computing device of claim 12 wherein the microstrip antenna is a PIFA.

16. The computing device of claim 12 wherein the means for holding the microstrip antenna is a scanning device, an RFID reader, a credit card reader, a camera or a strap holder.
